(19) United States
(12) Patent Application Publication
(10) Pub. No.: US 2009/0244784 A1
(43) Pub. Date: Oct. 1, 2009

(54) STORAGE APPARATUS

(75) Inventor: Shigeru Juman, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/410,993

(22) Filed: Mar. 25, 2009

(30) Foreign Application Priority Data
Mar. 27, 2008 (JP) 2008-084846

(51) Int. Cl. G11B 5/55

(52) U.S. Cl. 360/266.5; G9B/5.182

(57) ABSTRACT

A storage apparatus includes a magnetic circuit applying driving force to a carriage. The magnetic circuit includes a first yoke provided with a magnet. An end of the first yoke is secured using a first fastening member screwed in a threaded hole in an end of the base. A second yoke is opposed to the first yoke, and an end of the second yoke is secured using a second fastening member screwed in a threaded hole in another end of the base. A driving coil is held by the carriage and disposed between the first yoke and the second yoke so that the first yoke and the second yoke are attracted to each other by magnetic force of the magnet.

### CROSS-REFERENCE TO RELATED APPLICATIONS

This application is based upon and claims the benefit of priority of prior Japanese Patent Application No. 2008-84846, filed on Mar. 27, 2008, the entire contents of which are incorporated herein by reference

### FIELD

The embodiment discussed herein is related to a storage apparatus.

### BACKGROUND

In recent years, recording capacity in a magnetic disk apparatus has increased recording density due to improved performance of a magnetic head. Therefore, it is important to increase the precision with which data is written to the recording medium.

Here, in general, a voice coil motor (VCM) is used in a magnetic circuit used as a driving device for positioning the magnetic head with respect to a track on a magnetic disk. The magnetic circuit includes a driving coil, a permanent magnetic, and a pair of yokes; and will hereunder be referred to as a “magnetic circuit assembly.” The magnetic circuit assembly will be schematically described. The driving coil is mounted on an actuator, with the magnetic head being mounted on an end portion of the actuator. In addition, the permanent magnet and the pair of yokes are secured to a base enclosure provided at a housing. (For example, refer to Japanese Laid-open Patent Application Publication No. 2003-141872.)

A magnetic circuit assembly 5 constituting a general magnetic disk apparatus A′ will hereunder be described with reference to FIGS. 5 and 6. FIG. 5 illustrates an entire structure of the magnetic disk apparatus A′, and FIG. 6 is a perspective view of the magnetic circuit assembly 5.

As illustrated in FIG. 5, in the magnetic disk apparatus A′, a head assembly 2, an actuator 3, and the magnetic circuit assembly 5 are provided at predetermined locations of a base enclosure 12 provided at a housing 11. A magnetic head 1 is fixedly mounted to an end of the head assembly 2. The actuator 3 supports the head assembly 2, and swings around a pivot bearing 4 as a center. The magnetic circuit assembly 5 drives the actuator 3.

The magnetic circuit assembly 5 includes an upper yoke 6 and a lower yoke 7. Of the yokes 6 and 7, the lower yoke 7 is fastened to threaded holes (not illustrated) using fastening threaded members 10 inserted into through holes 8 and 9 formed in respective end portions of the lower yoke 7, to secure the magnetic circuit assembly 5 to a predetermined location of the magnetic disk apparatus A′. The threaded holes are formed in the base enclosure 12 of the magnetic disk apparatus A′.

However, the magnetic circuit assembly 5 of the magnetic disk apparatus A′ includes the following problems. That is, when writing or reading of data is started by rotating a magnetic disk, the temperature of the interior of the magnetic disk apparatus is gradually increased. Here, components used in the interior of the magnetic disk apparatus are formed of combinations of different types of metals and resin materials. Accordingly, since the materials of the components differ, when the environmental temperature is increased from ordinary temperature to a high temperature, or is reduced from a high temperature to a low temperature, differences between thermal expansions of the components cause a stress to be generated at coupling portions (mounting portions) of the components. When this stress exceeds a certain value, the stress is instantaneously released, thereby causing a high-frequency shock to be generated. Here, if a high-frequency shock is generated when writing data with the magnetic head 1 of the magnetic disk apparatus A′, the magnetic head 1 swings due to the shock exceeding the speed of a control frequency. As a result, problems, such as a data write error, may occur.

More specifically, as illustrated in FIG. 5, for the magnetic circuit assembly 5, the ferrous upper yoke 6 and the ferrous lower yoke 7 are fastened to the aluminum-type base enclosure 12 with respective fastening threaded members 10. Therefore, the probability with which a stress is generated by differences between thermal expansions at the coupling portions of the components is high. That is, when temperature is increased, for example, differences between thermal expansion coefficients of the components formed of different materials cause differences between displacements to occur, thereby causing distortion. When the distortion exceeds fastening forces of the threaded members, and, thus, is removed, a high-frequency shock is generated, thereby adversely affecting the magnetic head 1.

Here, as a measure against such shock caused by high frequency, for example, resin materials may be interposed between fastening portions where the threaded members are used. However, in this case, components are added, thereby, for example, increasing costs.

### SUMMARY

According to an aspect of the embodiment, a storage apparatus includes a magnetic circuit applying driving force to a carriage. The magnetic circuit includes a first yoke provided with a magnet. An end of the first yoke is secured using a first fastening member screwed in a threaded hole in an end of the base. A second yoke is opposed to the first yoke and an end of the second yoke is secured using a second fastening member screwed in a threaded hole in another end of the base. A driving coil is held by the carriage and disposed between the first yoke and the second yoke so that the first yoke and the second yoke are attracted to each other by magnetic force of the magnet.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic view of an entire structure of a magnetic disk apparatus.

FIG. 2 is a perspective view of the structure of a magnetic circuit assembly illustrated in FIG. 1.

FIG. 3 is a sectional view of the structure of the magnetic circuit assembly illustrated in FIG. 2.

FIG. 4 illustrates an example of mounting the magnetic circuit assembly illustrated in FIG. 2.

FIG. 5 is a schematic view of an entire structure of a general magnetic disk apparatus.

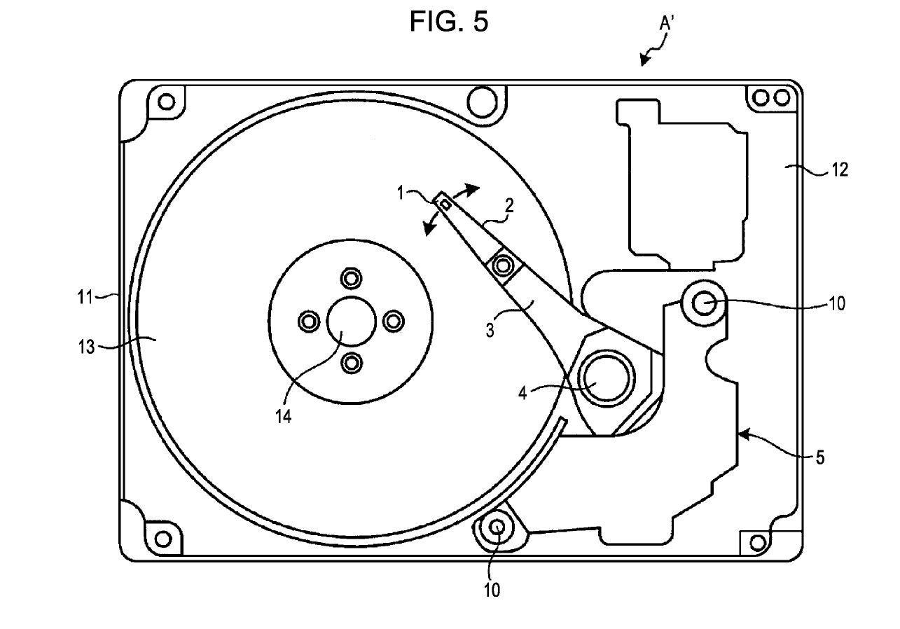

FIG. 6 is a perspective view of the structure of a magnetic circuit assembly.

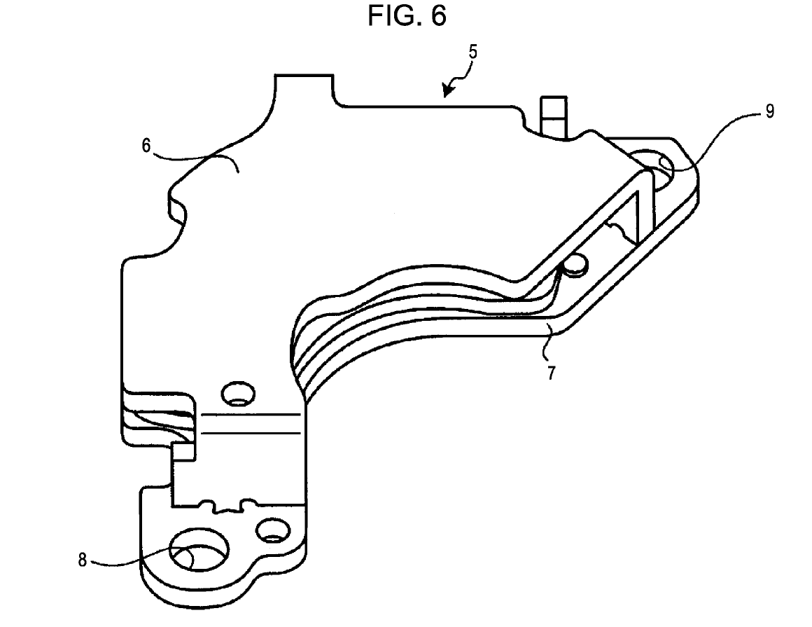

### DESCRIPTION OF EMBODIMENTS

Preferred embodiments of the present invention will be explained with reference to accompanying drawings.

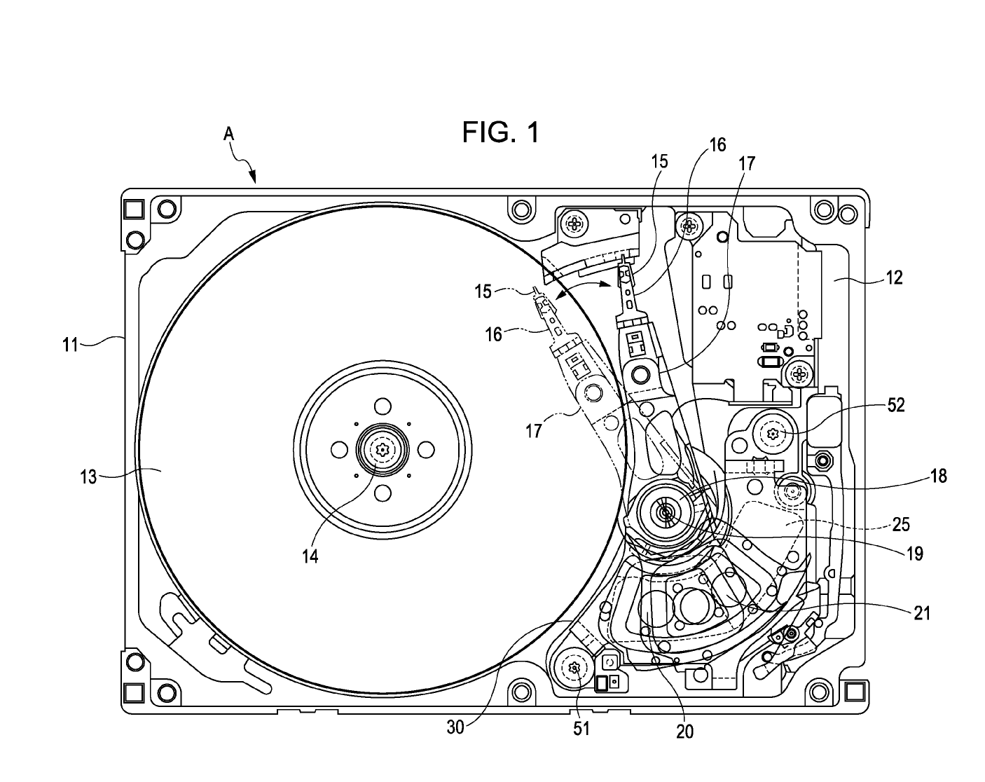

A storage apparatus of the present technology according to an embodiment will hereunder be described in detail with reference to the attached drawings. FIG. 1 is a schematic view of an entire structure of a magnetic disk apparatus.

Here, FIG. 1 illustrates a state in which a top cover of a magnetic disk apparatus A is removed, so that an internal structure of a base enclosure 12 constituting an inner portion of a housing 11 of the magnetic disk apparatus A is visible. The present technology is not limited by the embodiment that is hereunder described.

Here, in the embodiment, when a first yoke 30 (upper yoke) and a second yoke 40 (lower yoke), both of which constitute a magnetic circuit assembly 25, are together secured to the base enclosure 12, the first yoke 30 and the second yoke 40 (that is, the upper and lower yokes) are secured to one location of the base enclosure 12 instead of to a plurality of locations (two or three locations) of the base enclosure 12. In addition, ends of the first and second yokes 30 and 40 that are not secured to the base enclosure 12 are free ends, so that stress generated by thermal expansion differences occurring at coupling portions of the components is released.

For removing expansion caused by a thermal expansion difference occurring at the component coupling portion of the second yoke 40 and the base enclosure 12, the first yoke 30 and the second yoke 40 are coupled using attraction force of magnets, the strength of the coupling using attraction force being weaker than that of, for example, coupling of metals.

### [Structure of Magnetic Disk Apparatus]

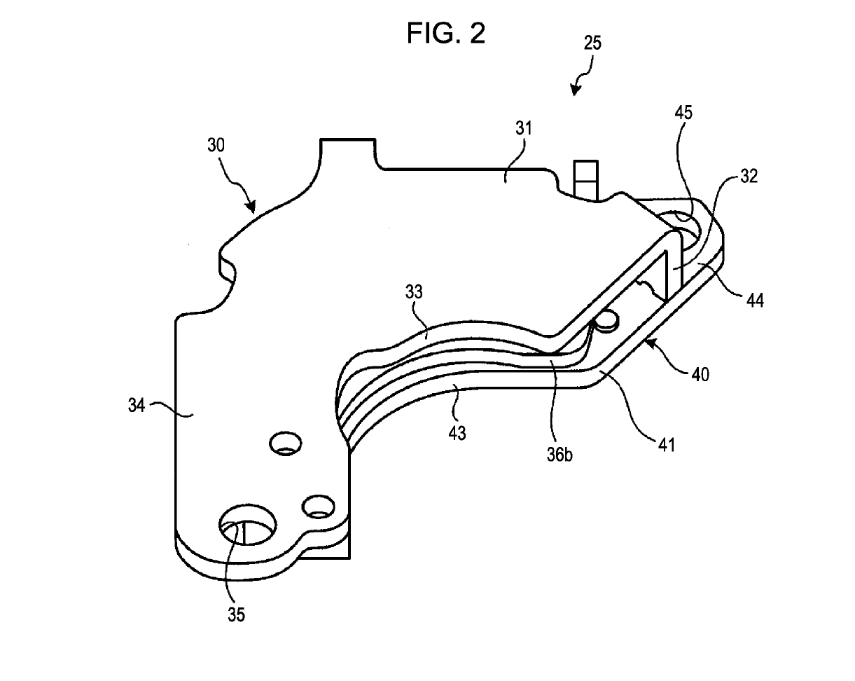

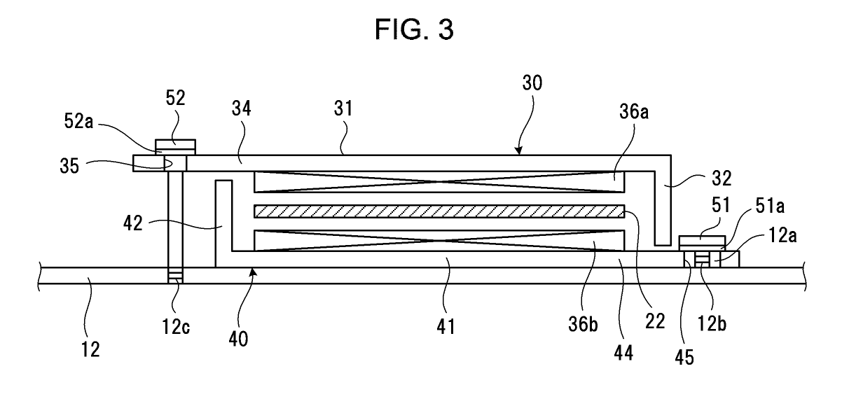

First, an entire structure of the magnetic disk apparatus A will be described with reference to FIG. 1. FIG. 1 is a schematic view of the structure of the magnetic disk apparatus A according to the embodiment. FIG. 2 is a perspective view of the structure of the magnetic circuit assembly 25. FIG. 3 is a sectional view of the structure of the magnetic circuit assembly illustrated in FIG. 2.

As illustrated in FIG. 1, in the magnetic disk apparatus A, a magnetic disk 13, a spindle motor 14, a head assembly 16, an actuator 17, and a magnetic circuit assembly 25 are provided at predetermined locations of the base enclosure 12 provided in the housing 11. The magnetic disk 13 is used for recording thereon various items of data and position control information. The spindle motor 14 rotationally drives the magnetic disk 13 at a predetermined speed. The head assembly 16 is fixedly mounted to an end of the magnetic head 15. The actuator 17 supports the head assembly 16, swings around a shaft 19 of a pivot bearing 18 as a center, and is used for positioning the magnetic head 15. The magnetic circuit assembly 25 serves as a driving device of the actuator 17. In FIG. 1, a position indicated by a broken line represents a load state of the magnetic head 15, whereas a position indicated by a solid line represents an standby state (unload state) of the magnetic head 15.

The magnetic head 15 includes an electromagnetic converting device comprising a reading element and a writing element. The magnetic head 15 reads various items of data and position control information from the magnetic disk 13, and writes them to the magnetic disk 13.

A VCM coil 22 and forked coil arms 20 and 21, supporting the VCM coil 22, are provided near the actuator 17. That is, the VCM coil 22 is interposed between the first yoke 30 and the second yoke 40 so that magnets 36a and 36b are maintained at a certain distance from each other. The VCM coil 22 swings the actuator 17 towards the left and right on the basis of application of current in a magnetic field generated by the magnets 36a and 36b.

### [Structure of Magnetic Circuit Assembly 25]

The structure of the aforementioned magnetic circuit assembly 25 will hereunder be described in more detail. As illustrated in FIGS. 2 and 3, the first yoke 30 in the magnetic circuit assembly 25 includes a body 31 which is substantially L shaped in cross section. A side plate 32, which is bent inwardly (downward in FIGS. 2 and 3) and substantially at right angles, is formed at a right end (in FIGS. 2 and 3) of the body 31. A curved portion 33, disposed near the pivot bearing 18, is formed towards the inner side of the body 31.

A linearly extending portion 34 is formed at a left end (in FIGS. 2 and 3) of the body 31. A through hole 35 for inserting a second fastening screw 52 for mounting the first yoke 30 to the base enclosure 12 is formed in an end of the extending portion 34.

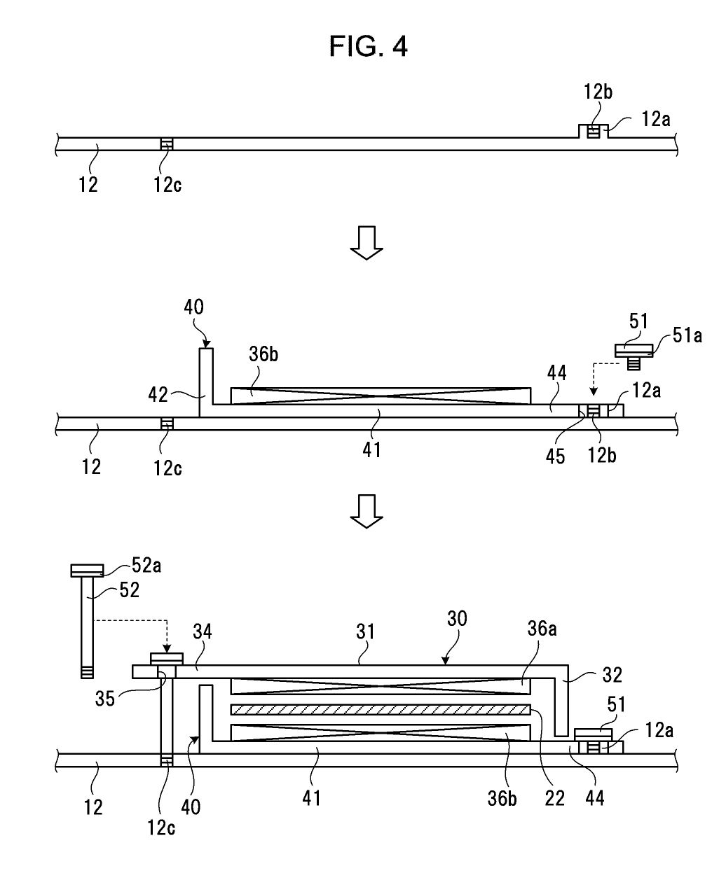

As described later, the second fastening screw 52 inserted into the through hole 35 of the first yoke 30 is screwed into a threaded hole 12c formed in a left end (in FIGS. 3 and 4) of the base enclosure 12, to fasten the first yoke 30 to the base enclosure 12. The magnet 36a is adhered and secured to the inner surface (lower surface in FIG. 3) of the first yoke 30.

As illustrated in FIGS. 2 and 3, the second yoke 4 includes a body 41 which is substantially L shaped in cross section as with the first yoke 30. A side plate 42, which is bent inwardly (upward in FIGS. 2 and 3) and substantially at right angles, is formed at a left end (in FIGS. 2 and 3) of the body 41. A curved portion 43, disposed near the pivot bearing 18, is formed towards the inner side of the body 41.

A linearly extending portion 44 is formed at a right end (in FIGS. 2 and 3) of the body 41. A through hole 45 for inserting a first fastening screw 51 for mounting the second yoke 40 to the base enclosure 12 is formed in an end of the extending portion 44. The magnet 36b is adhered and secured to the inner surface (upper surface in FIG. 3) of the second yoke 40.

A protrusion 12a is fixed to a right end (in FIG. 3) of the base enclosure 12, and a threaded hole 12b screwed to the first fastening member 51 is formed in the protrusion 12a. Here, the protrusion 12a formed at the base enclosure 12 is freely fitted to the through hole 45 formed at the right end (in FIG. 3) of the body 41 of the second yoke 40. The threaded hole 12c screwed to the second fastening member 52 is formed in the left end (in FIG. 4) of the base enclosure 12. A first resin material 51a is interposed between the first fastening member and the first yoke, and a second resin material 52a is interposed between the second fastening member and the second yoke.

Next, a general description of mounting the magnetic circuit assembly 25 will be given using FIG. 4. FIG. 4 illustrates an example of mounting the magnetic circuit assembly 25. That is, as illustrated in FIG. 4, first, the protrusion 12a, fixedly mounted to the right end (in FIG. 4) of the base enclosure 12, is fitted to the through hole 45 formed in the right end (in FIG. 4) of the body 41 of the second yoke 40. In addition, the first fastening member 51 is screwed into and fastened to the threaded hole 12b formed in the protrusion 12a. This makes it possible to mount and secure the second yoke 40 to the base enclosure 2.

Next, the threaded hole 12c, formed in the left end (in FIG. 4) of the base enclosure 12, and the through hole 35, formed in the body 31 of the first yoke 30, are aligned with each other. In addition, the second fastening member 52, inserted in the through hole 35 of the first yoke 30, is screwed into and fastened to the threaded hole 12c.

This makes it possible to mount and secure the first yoke 30 to the base enclosure 12. Accordingly, as illustrated in FIG. 4, the first yoke 30 and the second yoke 40 of the magnetic circuit assembly 25 can each be mounted and secured to the base enclosure 12 by a one-side joining operation.

When the first yoke 30 and the second yoke 40 are coupled and secured in this way, the first yoke 30 and the second yoke 40 are coupled by magnetic attraction between the magnet 36a, adhered to the first yoke 30, and the magnet 36b, adhered to the second yoke 40.

In other words, the coupling of the first yoke 30 and the second yoke 40 is achieved by making use of attraction force of magnets, the strength of the coupling using attraction force being weaker than that of, for example, coupling of metals. Therefore, expansion caused by thermal expansion differences occurring at the coupling portions of the first yoke 30 and the base enclosure 12 and the second yoke 40 and the base enclosure 12 can be absorbed at the fitting portions. This makes it possible to prevent a high-frequency shock generated by thermal expansion differences at the component coupling portions constituting the magnetic circuit assembly 25 from being produced.

As described above, the magnetic circuit assembly 25 according to the embodiment comprises the first yoke 30 (upper yoke) and the second yoke 40 (lower yoke). In addition, the magnetic circuit assembly 25 includes a one-side coupling structure, in which one end of the first yoke 30 is secured with the second fastening member 52 screwed into the threaded hole 35 formed at one end of the base enclosure 12, and one end of the second yoke 40 is secured with the first fastening member 51 screwed into the threaded hole 12b formed at another end of the base enclosure. Therefore, compared to the structure in which the lower yoke 7 is fastened at both sides, it is possible to restrict stress generated by thermal expansion differences of the component coupling portions constituting the magnetic circuit assembly 25, so that it is possible to prevent a high-frequency shock from being generated.

According to the storage apparatus of the present technology, the magnetic circuit has attached thereto a driving coil, fixedly mounted to a carriage, and magnets. In addition, the magnetic circuit comprises an upper first yoke and a lower second yoke, which are magnetized by magnetic force of the magnets and which oppose each other. One end of the first yoke is secured with a first fastening member screwed into a threaded hole formed at one end of a base, and one end of the second yoke is secured with a second fastening member screwed into a threaded hole formed at another end of the base. Therefore, in addition to reducing stress at coupling portions generated by changes in environmental temperature, a high-frequency shock, generated by thermal expansion differences at the coupling portions of the components, can be absorbed by releasing stress.

Further, the first yoke and the second yoke can be coupled by magnetization forces, the strength of the coupling using magnetization forces being weaker than that of, for example, screwing or coupling of metals. Consequently, it is easier to release generated stress.

Since the shapes of the first and second yokes of the magnetic circuit are the same, it is possible to form the components using a common material and to assemble the components efficiently. Therefore, costs can be reduced.

Another end of the first yoke of the magnetic circuit and another end of the second yoke of the magnetic circuit are free ends at outer sides, and are not secured to the base. Therefore, a high-frequency shock, generated by thermal expansion differences, can be absorbed by releasing stress.

Therefore, the technology is useful for a storage apparatus comprising a magnetic circuit. More particularly, the technology is effective in providing a storage apparatus capable of absorbing a high-frequency shock, generated by thermal expansion differences of coupling portions of components, by releasing stress.

All examples and conditional language recited herein are intended for pedagogical purposes to aid the reader in understanding the invention and the concepts contributed by the inventor to furthering the art, and are to be constructed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A storage apparatus that records information onto or reproduces the information from a storage medium, the storage apparatus comprising:
a base;
a head recording the information onto or reproducing the information from the storage medium;
a carriage carrying the head; and
a magnetic circuit applying driving force to the carriage, the magnetic circuit including:
a first yoke provided with a magnet, an end of the first yoke being secured using a first fastening member screwed in a threaded hole in an end of the base,
a second yoke opposed to the first yoke, an end of the second yoke being secured using a second fastening member screwed in a threaded hole in another end of the base, and
a driving coil held by the carriage and disposed between the first yoke and the second yoke so that the first yoke and the second yoke are attracted to each other by magnetic force of the magnet.

2. The storage apparatus according to claim 1, wherein a shape of the first yoke of the magnetic circuit and a shape of the second yoke of the magnetic circuit are the same.

3. The storage apparatus according to claim 1, wherein another end of the first yoke of the magnetic circuit and another end of the second yoke of the magnetic circuit are free ends at outer sides, the free ends not being secured to the base.

4. The storage apparatus according to claim 2, wherein another end of the first yoke of the magnetic circuit and another end of the second yoke of the magnetic circuit are free ends at outer sides, the free ends not being secured to the base.

5. The storage apparatus according to claim 1, wherein the first fastening member, screwed in the threaded hole in the end of the base, and the second fastening member, screwed in the threaded hole in the another end of the base, are screwed while a first resin material is interposed between the first fastening member and the first yoke, and a second resin material is interposed between the second fastening member and the second yoke.

6. The storage apparatus according to claim 2, wherein the first fastening member, screwed in the threaded hole in the end of the base, and the second fastening member, screwed in the threaded hole in the another end of the base, are screwed while a first resin material is interposed between the first fastening member and the first yoke, and a second resin material is interposed between the second fastening member and the second yoke.

7. The storage apparatus according to claim 3, wherein the first fastening member, screwed in the threaded hole in the end of the base, and the second fastening member, screwed in the threaded hole in the another end of the base, are screwed while a first resin material is interposed between the first fastening member and the first yoke, and a second resin material is interposed between the second fastening member and the second yoke.
